(19) United States
(12) Patent Application Publication
(10) Pub. No.: US 2008/0021870 A1
(43) Pub. Date: Jan. 24, 2008

(54) Social Network of Identities and Query Method Therefor

(76) Inventors: Scott Birnbaum, New York, NY (US); Nigel Simmons, Potomac, MD (US); Adarbad Master, Bethesda, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/564,638

(22) PCT Filed: Jul. 15, 2004
(86) PCT No.: PCT/US04/18933

§ 371 Date: Aug. 21, 2007

Related U.S. Application Data
(60) Provisional application No. 60/487,191, filed on Jul. 15, 2003.

(51) Int. Cl. G06F 7/10; G06F 15/16; G06F 17/30

(52) U.S. Cl. 707/3; 707/104.1; 709/203; 707/E17.009; 707/E17.014

(57) ABSTRACT

The method of gathering information within a social network of identities in which people or other identities have social relationships with one another, such as personal or business relationships, and each person has an identity account (101) containing information about that person. The identity accounts reside on identity servers (150A, 150B, 150N) connected by way of a computer network (110A, 110B, 110N). Information, such as address and telephone information, is held in each person's identity account (101). The identity accounts (101) can be queried based on the social relationships to find information. One person can query a second person's contact information. The second person can then query others known to that second person for the information. Electronic contracts embody agreements between the people in the social network, specify the terms and conditions for using data in the identity accounts, and can limit the information returned to the person making the query.

### BACKGROUND OF THE INVENTION

1. Related Application

This application claims priority to U.S. provisional patent application Ser. No. 60/487,191, filed Jul. 15, 2003, which is incorporated herein by reference.

2. Field of the Invention

The invention generally relates to computer networking. More particularly, the invention relates to a social network based on identities of individuals.

3. Description of the Related Art

U.S. Pat. Nos. 6,345,288 and 6,088,717, the paper “From Name Service to Identity Service: How XNS Builds on the DNS Model,” Jul. 9, 2002, (http://www.xns.org/pages/From_Name_to_Identity.pdf), and the “XNS Technical Specifications,” Jul. 9, 2002, (http://www.xns.org/pages/XNS_Technical_Specs.pdf), describe techniques for communicating information between entities represented as identities in a computer network based on an agreement between the entities which specifies the data to be transferred and/or exchanged. These references are incorporated herein by reference.

The techniques described in these references, however, do not take advantage of social relationships that exist between entities, including people, organizations and businesses in order to assist entities in locating and sharing information. The social network of identities described herein uses these social relationships to help entities locate and share information.

### SUMMARY OF THE INVENTION

A method of gathering information in a social network is described in which the information is requested by a first entity. The social network includes the first entity, a second entity and a third entity. The first and second entities have a social relationship, and the second and third entities have a social relationship. Each of the first, second and third entities have first, second and third identity accounts, respectively, embodied on one or more computers connected in a computer network. The first and second entities have an electronic contract specifying data the first and second entities have agreed to share, and the second and third entities have an electronic contract specifying data the second and third entities have agreed to share. The method includes receiving a request for the information requested by the first entity and searching for the information in response to the request. If the information is located in the second identity account, the method sends the information in response to the request for information if the information corresponds to the data specified in the electronic contract between the first and second entities. If the information is located in the third identity account, the method sends the information in response to the request for the information if the information corresponds to the data specified in the electronic contract between the second and third entities.

The method can include the second entity identifying the third entity based on a social relationship between the second and third entities. In another alternative, the method sends the information in response to the request for information to the first identity if the information corresponds to the data specified in the electronic contract between the first and second entities if the located information has been sent to the second entity,

An apparatus is described here for participating in a computerized social network of users. The apparatus includes an identity account associated with a first one of the users in the social network, which contains information about the first user. The apparatus also includes an electronic contract specifying information in the identity account for sharing with a second one of the users in the social network. The apparatus further includes a means for qualifying the information specified in the identity account to be shared with the second user based on a type of relationship between the first and second users. In one instance, the type of relationship between the first and second user is a personal relationship and the means for qualifying the information specified in the identity account qualifies the information to output to the second user, information that is suitable for sharing in a personal relationship. In another instance, the type of relationship between the first and second user is a business relationship and the means for qualifying the information specified in the identity account qualifies the information to output to the second user, information that is suitable for sharing in a business relationship. In still another instance, the relationship is reflected in the electronic contract. Here, the type of the relationship includes at least one of a person-to-person, person-to-business, person-to-organization, commercial, and business relationship.

### BRIEF DESCRIPTION OF THE DRAWINGS

FIG. 1 is an illustration of plurality of computers that form a social network based on the digital identities of people, organizational entities or resources, and the relationships between those people, organizational entities or resources. Such a network is referred to as a social network of identities.

FIG. 2A is an illustration of an identity account used in the social network of FIG. 1.

FIG. 2B is an illustration of a second embodiment of the identity account used in the social network of FIG. 1, which employs electronic contracts.

FIG. 2C is an illustration of a third embodiment of the identity account used in the social network of FIG. 1, which employs electronic contracts.

FIG. 2D is an illustration of a fourth embodiment of the identity account used in the social network of FIG. 1, which employs electronic contracts.

FIG. 3 is a flowchart of a process for querying the social network of identities shown in FIG. 1.

FIGS. 4A and 4B show examples of logical relationships within a social network of identities that are used in querying the network.

### DETAILED DESCRIPTION

The following description makes reference to the above drawings, in which like reference numerals designate like components.

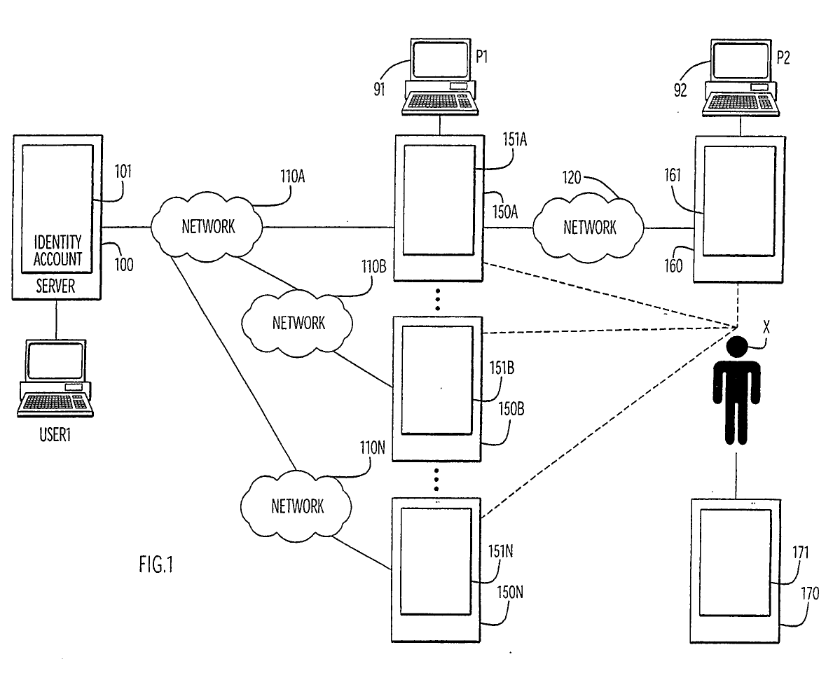

FIG. 1 shows a plurality of computers forming a social network of identities based on the entities using those computers. Such entities can include individual persons, organizations, businesses or other groups. The embodiments described below generally are described in terms of an individual person, however, it should be understood that a wide array of other types of entities, including businesses and organizations, can use the social networks described herein. The computers shown in FIG. 1 represent only one example of the types of devices that can be used to form the social network of identities. Other devices that can be used in the social network of identities include, but are not limited to, personal digital assistants (“PDA”), cellular telephones and many other types of computing devices

In the social network of FIG. 1, a user, USER1, using a client workstation 90 has an established identity account 101 that resides on a server computer, such as USER1's identity server 100. An identity account contains information about a user, e.g., identity account 101 can contain USER1's personal contact information and USER1's work contact information and also may also be linked to other applications, e.g., USER1's electronic address book, that employ the information contained in the identity accounts.

Identity server 100 can store and manage the identity accounts of many different users, although only one identity account 101 is shown in FIG. 1 for ease of illustration. Identity server 100 communicates over communications networks, such as the Internet (shown in FIG. 1 as a plurality of connected communication networks 110A, 110B through 110N) with other identity servers, such as identity servers 150A, 150B through 150N. Another identity server, identity server 150A, maintains the identity account of another person, P1, whose identity account 151A can communicate with USER1's identity account 101 over a network 110A. Similar to the communication connection between identity server 100 associated with USER1 and identity server 150A associated with P1, identity server 150A can communicate with another identity server, identity server 160, that contains an identity account 161 of another person, P2, whose identity account 161 can communicate with P1's identity account 151A over a network 120.

The identity accounts shown in FIG. 1 hold information about an entity, here a person. This information describes certain attributes about the person to identify that person in some respect. For example, an identity account may contain a person's home and work contact information. Additionally, an identity account associated with a person may contain or reference contracts established between members of a social network of identities and a user associated with the identity account. These contracts govern the sharing of information between a user and another member of a social network of identities. The identity account can also contain, e.g., the contents of a user's electronic address book, the names and identities of other members of a social network of identities or links to other applications, such as a user's electronic address book.

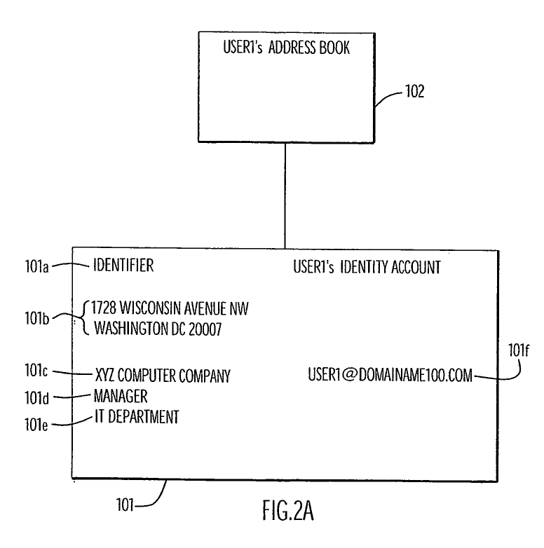

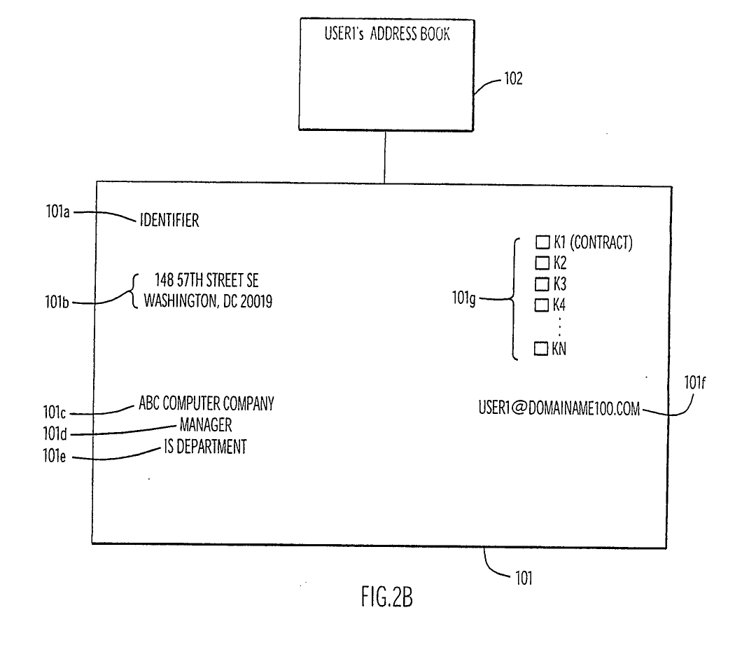

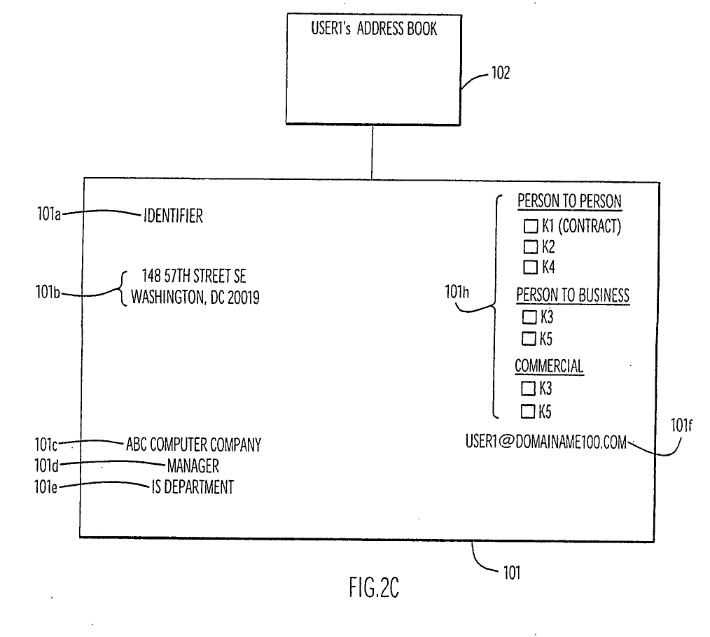

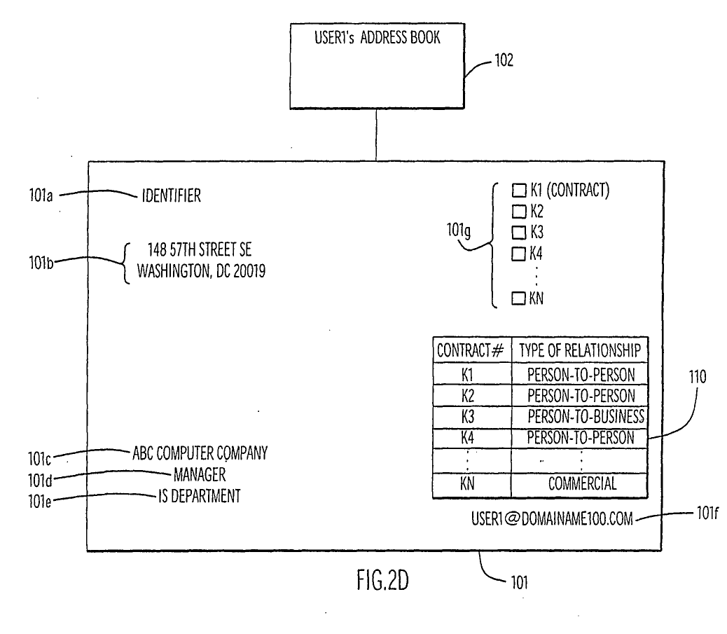

An exemplary embodiment of identity account 101 is conceptually illustrated in FIG. 2A. FIG. 2A shows an identity account containing information about USER1, such as a persistent identifier 101a for the entity, USER1, that is unique throughout the social network of identities, USER1's address 101b, company name 101c, title 101d, department 101e, and e-mail address 101f. In addition to identity account 101 shown in FIG. 2, a user may also have an electronic address book 102. In one embodiment, electronic address book 102 exists separate from identity account 101, but is linked to identity account 101 such that the when identity account 101 is searched, electronic address book 102 is also searched. In an alternative embodiment, electronic address book 102 is incorporated into identity account 101 allowing the contents of electronic address book 102 to be searched. In another alternative embodiment, the contents of electronic address book 102 may be imported into identity account 101. Such an embodiment allows the context of the electronic address book 102 to be imported into identity account 102 in a format compatible with the query method described below, e.g., XML format.

FIG. 2B illustrates another identity account that includes a plurality of contracts K1, K2 . . . KN. FIG. 2B is similar to FIG. 2A, except that contracts 101g are contained within the identity account 101 of FIG. 2B. Contracts can reflect the relationships that exist between people in a social network of identities, as they specify the information or data that one person makes accessible to another person within the social network. More specifically, a contract defines the specific data items within the identity account of one person that are made accessible to the identity account of another person in the social network. For example, as illustrated in FIG. 2B, a contract K1 in identity account 101 of USER1 specifies whether certain information may be shared with another person's, e.g., P1's, identity account.

A conventional digital identity account contract can be extended to indicate the type of relationship that exists between the respective entities. Knowing the type of relationship between two entities can sometimes facilitate a search through the social network of identities. For example, if USER1 and P1 are both people, then the type of relationship between them can be indicated as a “person-to-person” relationship in the contract itself. Based on the type of relationship between two entities, there can be a common set of attributes present in all the contracts that reflect the same type of relationship. For example, all contracts of the type “person-to-person” can be configured to allow sharing of specific information, such as address information. This, however, is only one example of an attribute that could be common to all “person-to-person” type relationships.

The relationships between entities having identity accounts can be further qualified. For example, the people in a “person-to-person” relationship can have a personal relationship as opposed to a strictly business relationship. Because these people have a personal relationship, a certain level of trust is implied between those people such that it is likely that they are willing to share more or different types of information than if their relationship is strictly a business relationship, for example. Capturing within a contract the type of relationship two entities share enables identity applications to leverage those relationships to effectively share information.

Also, as illustrated in FIG. 2B, an identity account 101 can include a plurality of contracts 101g. Each of those contracts 101g represents a relationship with another entity having an identity account in the social network. As discussed above, even though contracts within an identity account may specify different information to share under possibly different terms and conditions, contracts that reflect the same types of relationships between identity accounts can have common attributes. Also, the contracts between different identity accounts can reflect the different types of relationships that may exist between people and their respective identity accounts, i.e., P2 may be a personal friend and also a business colleague of P1, thus a contract between respective identity accounts of P2 and P1 can reflect both of the two above-mentioned different types of relationships.

Another identity account 101 is shown in FIG. 2C which is similar to the identity account in FIG. 2B, except the contracts 101h are organized into different categories based on the types of relationships that they represent. For example, contracts K1, K2, and K4 represent relationships between USER1, who is associated with identity account 101, and other people, each associated with other identity accounts, where the other people are people with whom USER1 has personal relationships. Contracts K3 and K5 represent relationships between identity account 101 and other identity accounts, where those other identity accounts are for businesses. Contracts K6 and K7 reflect the relationships between identity account 101 and identity accounts for other entities that share a commercial relationship with USER1. Thus, the contracts 101h of FIG. 2C are categorized such that they respectively represent the types of relationships USER1 has with the other entities in the social network. However, unlike FIG. 2B, the contracts 101h in the identity account 101 of FIG. 2C do not contain therein information about the types of relationships between identity accounts. Rather that information is specified by the grouping of the contracts 101h.

Similar to FIGS. 2B and 2C, FIG. 2D also shows an exemplary embodiment of an identity account having contracts 101g therein. However, unlike FIGS. 2B and 2C, FIG. 2D includes a table 110 that indicates the types of relationships reflected in the respective contracts 101g. For example, table 110 in FIG. 2D specifies that contracts K1, K2, and K4 reflect a person-to-person, personal relationships between identity account 101 and another identity account, contract K3 reflects a person-to-business relationship, that is a business relationship, and contract KN reflects a commercial relationship.

In summary, FIGS. 2B-2D, as described above, show how identity accounts and contracts contained therein can be associated with information about the type of relationship to qualify the terms of the contract. This qualification of the type of relationship is utilized in a social network to define the parameters of relationships between entities and their identity accounts and to reflect the types of relationships that exist between particular entities and their identity accounts.

In the social network shown in FIG. 1, each identity account has a unique, persistent and immutable network identifier such as identifier 101a shown in FIG. 2A. An embodiment of the identifier takes the form “: HOSTID : IDENTITYID”. An example of such an identifier is “urn:xri://.10.1.2.3:238” which specifies a host address “.10.1.2.3” and a particular user or resource identifier 238 located at host address 10.1.2.3. Such an identifier can be referenced in other identity accounts in the social network. Thus, the identifier being a unique identifier that identifies a specific resource can represent a link in the social network to that resource. For example, data in an identity account that relates to the identity account of a personal contact, e.g., P1, can also include information about the network location of that identity account by specifying its identifier. The identity account can also contain links to other applications, such as a user's electronic address book. The social network of identities can link multiple identity accounts in the network to one another, where the links represent relationships that have been established between people. Such relationships can be enforced by the identity accounts using electronic contracts that dictate the actions one identity account may perform relative to another identity account with which it has the contract.

Based on the social network of identities, as described above, a user can more easily obtain information about other entities than previously possible. For example, the network shown in FIG. 1 allows a user, e.g., USER1, to answer the question “Who do I know that directly or indirectly knows X?”, where X is the subject of USER1's query.

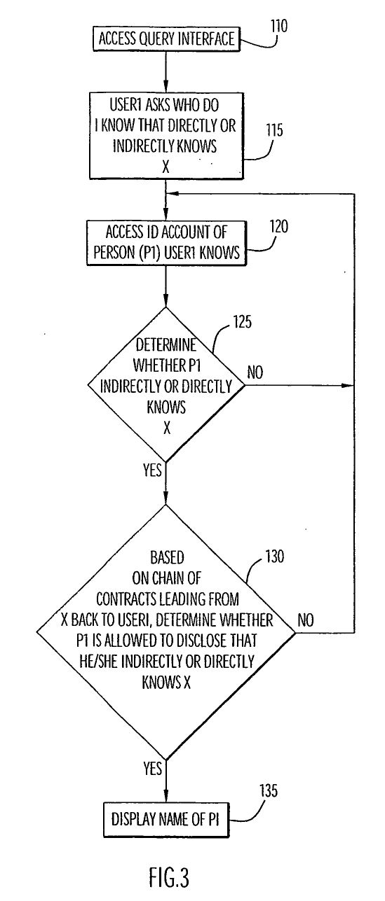

FIG. 3 shows an example of a process for making such a query. At step 110, USER1 in the social network of FIG. 1 uses a query interface accessed at client workstation 90 to input, at step 115, USER1's query and seek the answer to the question “Who do I know that directly or indirectly knows X?” at step 115. The inquiry can be input by way of typing, voice recognition or by using various other well known methods of inputting information.

In step 120, P1's identity account 151A shown in FIG. 1 is accessed, where P1 is an entity that USER1 knows and with whom USER1 has a contract to share data. In this example, the server 150A and identity account 151A, shown in FIG. 1, are the server and identity account of person P1. Next, in step 125, the process determines whether P1 knows person X either directly or indirectly by searching P1's identity account 151A and possibly certain of P1's applications, such as P1's electronic address book, for X. That is, the process first determines whether P1 directly knows X. If P1 does not directly know X, the process then determines whether P1 indirectly knows X, possibly through P1's relationship with another person, e.g., P2, who has a contract to share data with P1. P1's identity account 151A sends a query to those identity accounts with which P1 has a contract to share information. In this example, identity account 151A sends a request containing USER1's query to identity account 161 associated with P2, P2 being a person with whom P1 has a contract to share information. Identity account 161 and possibly certain of P2's applications are then searched for X.

While in the above example, identity account l51A sends a request with the query to identity account 161 only if the search of identity account 151A is not successful in finding X, in an alternative embodiment identity account 161 is always searched regardless of whether X is found in identity account 151A.

If it is determined that P1 indirectly or directly knows X, then the process shown in FIG. 3 proceeds to step 130, where it is determined whether a contract or a chain of contracts exist allowing P1 to share the results of the query with USER1, as discussed below. If it is determined that such contracts exists, then the name of and possibly contact information for P1 can be displayed to USER1 in step 135. Alternatively, the results of the query can be sent to USER1. However, if it is determined that the contractual agreements do not allow P1 to disclose that P1 directly or indirectly knows X, then the process returns to operation 120 and a different identity account, e.g., identity account 151B, is then searched.

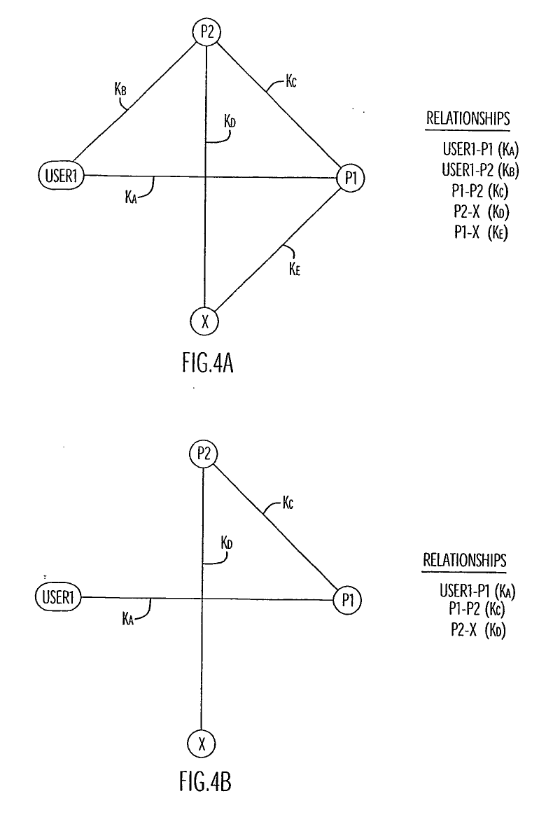

FIGS. 4A and 4B depict examples of the types of relationships that can exist between members of a social network of identities and illustrates the contractual relationships between those entities. In FIG. 4A, USER 1, P1 and P2 represent members of social network having identity accounts as shown in FIG. 1. X represents the subject of USER1's query “Who do I know that indirectly or directly knows X.” Contracts exist between the identity accounts of USER1, P1 and P2 illustrated by the lines connecting those entities. For example, as shown in FIG. 4A, USER1 and P2 have a contract K_{B} and P2 and P1 have a contract K_{C}. Accordingly, USER1 directly knows P1 and P2 as shown in FIG. 4A, and USER1 indirectly knows X through both P1 and P2. The contracts govern the sharing of information between the members of the social network.

As an example of the searching operation, assume USER1 directly knows P1 who directly knows P2 (as shown in FIG. 4B). A query of P1's identity account does not locate X. However, a query of P2's identity account determines that P2 does know X. In this example, before P2 shares information with P1, it must first be determined if the terms of contract Kc allow P2 to share the information with P1. If so, the information is sent to P1. Then it must be determined if contract Kc allows P1 to share the information with USER1. It must also be determined if the terms of contract KA permit P1 to share the information with USER1. If all the contracts in the chain of contracts between USER1 and the entity having information about X permit USER1 to ultimately view the information, the information is sent to USER1 for display to USER1 at client workstation 90. Alternatively, USER1 could receive a notification of which member of the social network has the information that USER1 has inquired about. USER1 could thus request that information from its source. Thus, contracts must exist between all identity accounts that communicate during a particular query in order for information to be passed from one identity account to another.

Returning to operation 125 in FIG. 3, if P1 does not directly or indirectly have a relationship with X, then the process returns to operation 120, and the identity account of the next entity that has a contract with P1's identity account, is accessed to determine whether this next entity directly or indirectly has a relationship with X. Thus, the query process shown in FIG. 3 is a sequential process of iterating through contracts within the identity account. However, the query process is not limited to such a sequential query process, and alternatively a parallel query process could be used.

In one embodiment, the information stored in the identity accounts is stored as XML data according to an XML schema, the XML schema having a variety of attributes. One example of an XML scheme would be a contact schema. The contact schema has several defined attributes, e.g., name, home phone number, work phone number, work address, home, address, work e-mail address, home e-mail address, etc. When USER1 accesses the query interface at step 110, USER1 is required to input a structured query corresponding to the attributes of the appropriate XML schema, here the contact schema. As an example, USER1 may input USER1's query into a field that will query the work address attribute of the contact schema. For example, USER1 may input “1600 Pennsylvania Avenue” into the work address filed of the query interface. The querying process as described above and illustrated in FIG. 3 will then search the work address attributes of the appropriate identity accounts for any identity accounts containing “1600 Pennsylvania Avenue.” Another attribute that can exist in the contact schema is profession. This attribute would support searches over the social network by job function. For example, USER1 could query his social contacts with the query “who do I know who knows an accountant?” The social network query would query all the people who USER1 directly knows. The identity accounts for those people would respond to the query with the contact information of accountants in their electronic address books. Since USER1 directly knows the people whose identity accounts respond to the query, USER1 has a certain degree of trust that the responses include the names of accountants who USER1 would want to contact. Similarly, the identity accounts for people who USER1 indirectly knows will respond with names of accountants that are in the electronic address books of those people. USER1 might give less weight to the names of the accountants that came from indirect contacts, however USER1 accords a certain amount of weight to that information based on USER1 knowing the respondents indirectly.

The information in the identity account can be qualified, using attributes in an XML schema to correspond with the social relationship between the entities. For example, certain XML attributes can be classified as corresponding to a person-to-person relationship (e.g., home address, home telephone number, etc.). Other attributes (e.g., business address, business phone, etc.) can be qualified using XML attributes to correspond with a person-to-business or business-to-business type relationship. Using various query mechanisms, such as XQuery for XML, searching for information based on social relationships can be accomplished.

Additionally, a contract within a specific identity account can be configured to allow other identity accounts with which the specific identity account corresponds, to automatically receive information from the specific identity account when information changes therein. That is, when information in an identity account changes, that information can be propagated to other identity accounts in accordance with the contractual terms between the respective identity accounts.

For example, if address information in identity account 161 is changed, the changed information can be “pushed” to another identity account 151A based on a contractual obligation to push this information to identity account 151A when it changes. The mechanisms for performing the above-described push operation can exist within the contract itself. Also, it should be recognized that the above described propagation process is only one example of a method by which information can be distributed in the social network of identities. Identity account 151A can then push the changed address information to identity account 101 if identity account 151A had previously sent similar information to identity account 101 in response to a query and the chain of contracts so permits.

Having described embodiments invention as set forth above, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

What is claimed is:

1. A method of gathering information in a social network requested by a first entity, wherein the social network includes the first entity, a second entity and a third entity, the first and second entities having a social relationship, and the second and third entities having a social relationship, wherein each of the first, second and third entities have first, second and third identity accounts, respectively, embodied on one or more computers connected in a computer network, wherein the first and second entities have an electronic contract specifying data the first and second entities have agreed to share, and the second and third entities have an electronic contract specifying data the second and third entities have agreed to share, the method comprising,
receiving a request for the information requested by the first entity;
searching for the information in response to the request; and
if the information is located in the second identity account, sending the information in response to the request for information if the information corresponds to the data specified in the electronic contract between the first and second entities, and if the information is located in the third identity account, sending the information in response to the request for the information if the information corresponds to the data specified in the electronic contract between the second and third entities.

2. The method according to claim 1, wherein the second entity identifies the third entity based on a social relationship between the second and third entities.

3. The method according to claim 1, wherein if the information located in response to the request for the information is sent to the second entity, sending the information in response to the request for information to the first identity if the information corresponds to the data specified in the electronic contract between the first and second entities.

4. An apparatus for participating in a computerized social network of users, comprising:
an identity account associated with a first one of the users in the social network, the identity account having information about the first user;
an electronic contract specifying information in the identity account for sharing with a second one of the users in the social network; and
means for qualifying the information specified in the identity account to be shared with the second user based on a type of relationship between the first and second users.

5. The apparatus of claim 4, wherein the type of relationship between the first and second user is a personal relationship and the means for qualifying the information specified in the identity account qualifies the information to output to the second user information that is suitable for sharing in a personal relationship.

6. The apparatus of claim 4, wherein the type of relationship between the first and second user is a business relationship and the means for qualifying the information specified in the identity account qualifies the information to output to the second user information that is suitable for sharing in a business relationship.

7. The apparatus according to claim 4, wherein a type of the relationship is reflected in the electronic contract.

8. The apparatus according to claim 7, wherein the type of the relationship comprises at least one of person-to-person, person-to-business, person-to-organization, commercial, and business.

9. A method of obtaining information about an entity among a plurality of entities in a social network, wherein the social network includes a plurality of identity accounts associated with the plurality of entities, respectively, wherein between the plurality of identity accounts are electronic contracts, the method comprising:
requesting information related to the entity; and
receiving the requested information related to the entity based at least on a social relationship established between the entity and a second entity having an identity account.

10. The method according to claim 9, wherein the entity is one of a person, a business, a group, and an organization.

11. The method according to claim 9, wherein the relationship is based on an electronic contract between the entity and the second entity.

12. The method according to claim 9, wherein a type of the relationship is reflected in an electronic contract.

13. The method according to claim 12, wherein the type of the relationship comprises at least one of person-to-person, person-to-business, person-to-organization, commercial, and business.

14. A method of obtaining information in a social network, the social network having a plurality of identity accounts wherein each identity account of the first plurality of identity accounts is associated with an entity and wherein an exchange of information between the plurality of identity accounts is governed by electronic contracts, the method comprising:
a first identity account receiving a query from a second identity account, the exchange of information between the first identity account and second identity account being governed by an electronic contract, the query containing a request for certain information about the contents of the first identity account;
searching the first identity account for the certain information to determine if the first identity account contains the certain information;
if the first identity account contains the certain information, determining if the first identity account is permitted to exchange the certain information with the second identity account based on the electronic contract between the first identity account and the second identity account; and
sending the certain information to the second identity account if it is determined that the electronic contract so permits.

15. The method according to claim 14, wherein if in response to searching the first identity account for the certain information it is determined that the certain information is not contained in the first identity account, the first identity account queries a first plurality of identity accounts with which the first identity account has an electronic contract to exchange information;
if any of the identity accounts of the first plurality of identity accounts contains the certain information, determining if said any of the identity accounts of the first plurality of identity accounts is permitted to exchange the certain information with the first identity account based on the electronic contract between the first identity account and said any of the identity accounts of the first plurality of identity accounts; and
sending the certain information to the first identity account if it is determined that the electronic contract between the first identity account and said any identity accounts of the first plurality of identity accounts permits exchanging the certain information.

16. The method according to claim 15, wherein after searching the first identity account for the certain information, the first identity account queries a first plurality of identity accounts with which the first identity account has an electronic contract to exchange information;
if any of the identity accounts of the first plurality of identity accounts contains the certain information, determining if said any of the identity accounts of the first plurality of identity accounts is permitted to exchange the certain information with the first identity account based on the electronic contract between the first identity account and said any of the identity accounts of the first plurality of identity accounts; and
sending the certain information to the first identity account if it is determined that the electronic contract between the first identity account and said any identity accounts of the first plurality of identity accounts permits exchanging the certain information.

17. The method according to claim 15, wherein if the first identity account receives the information from said any of the identity accounts of the first plurality of identity accounts, the information is sent to the second identity account if it is determined if the electronic contract between the first identity account and the second identity account permits exchanging the certain information.

18. The method according to claim 16, wherein if the first identity account receives the information from said any of the identity accounts of the first plurality of identity accounts, the information is sent to the second identity account if it is determined if the electronic contract between the first identity account and the second identity account permits exchanging the certain information.
